(19) United States
(12) Patent Application Publication
(10) Pub. No.: US 2014/0117125 A1
(43) Pub. Date: May 1, 2014

(54) IRON ORE CONCENTRATION PROCESS WITH GRINDING CIRCUIT, DRY DESLIMING AND DRY OR MIXED (DRY AND WET) CONCENTRATION

(71) Applicant: VALE S.A., Rio de Janeiro (BR)

(72) Inventor: Joaquim Donizetti DONDA, Lourdes (BR)

(73) Assignee: VALE S.A., Rio de Janeiro (BR)

(21) Appl. No.: 14/063,478

(22) Filed: Oct. 25, 2013

Related U.S. Application Data
(60) Provisional application No. 61/719,143, filed on Oct. 26, 2012.

(51) Int. Cl. B02C 19/00; B02C 23/20; B02C 23/08; B03C 1/00

(52) U.S. Cl. CPC B02C 19/0056; B03C 1/002; B02C 23/20; B02C 23/08
USPC 241/20; 241/24.25

(57) ABSTRACT

The present invention discloses an advantageous and effective process for the concentration of iron ores, which can be fully dry or mixed, part of the process being dry, part wet. The invention thereby improves process efficiency as a whole by increasing recovery of concentrators and increasing the useful life of the mines.

### CROSS REFERENCE TO RELATED APPLICATION

This application claims priority from U.S. Provisional Application No. 61/719,143, entitled “Specification for Iron Ore (Itabirite) Concentration Process with Milling Circuit and Dry Desliming and Dry or Wet Concentration,” filed on Oct. 26, 2012, and which is incorporated herein by reference.

### FIELD OF THE INVENTION

The present invention relates to a concentration process for iron ores, which can be fully dry or mixed, part of the process being dry, part wet.

### BACKGROUND OF THE INVENTION

A concentration facility, hereinafter referred to as “Concentrator,” is typically defined by a combination of one or more unit operations. Concentrators are usually large-scale facilities capable of processing thousands of tons of ore per day.

To recover metals and other minerals for use in industrial processes, significant quantities of ore or rock are mined, crushed, pulverized and processed. Nowadays, it is often desirable to process minerals with contents above 35% iron to obtain concentrates with up to 68% iron. Such processes are carried out with dry and/or partially wet processing stages. Dry processing normally goes from mining (extraction of the ore in the mine) up to sieving and crushing operations. When processing natural fines from ores, a wet processing stage is conducted after the crushing operation and involves the addition of large quantities of water. This wet stage begins at grinding. Grinding is necessary to release metals and minerals from the ore or rock. Therefore, the mining industry produces large quantities of fine ore or rock particles where such fine grained wastes are known as “tailings.”

The most common ore concentration process, capable of processing large quantities of ore, is flotation, carried out in mechanical cells or flotation columns. Flotation may require a desliming stage, which consists of the extraction of the natural ultrafines and can include extraction of those generated in the grinding process. This is done on a wet basis and requires the movement of large volumes of water, as well as the placement of sandy tailings and slimes from the process in dams.

FIG. 1 shows a flowchart typical of a known process in which all of the material originating from the mine is processed for the production of concentrates.

FIG. 2 shows a flowchart used for processing more complex minerals that require a second stage of grinding to guarantee the liberation of iron ore from the gangue.

The process of reverse flotation is already industrially used at various plants and companies.

The process of concentration after the first grinding stage, as described in FIG. 2, can be flotation or wet high intensity magnetic separation.

### BRIEF SUMMARY OF THE INVENTION

In one embodiment, the invention provides an iron ore concentration process with grinding circuit, dry desliming and dry concentration, wherein the process comprises the steps of: a) crushing an ore; b) dry grinding of the ore crushed in step a); c) dry desliming of the ore grinded in step b); and d) magnetically separating the ore deslimed in step c), resulting in a concentrate product and a reject. Step b) may be performed by pneumatic classifiers, with a cut between about 90%<37 μm and about 90%<5 μm. Step d) is performed by magnetic drums using a combination of low and medium intensity magnetic fields followed by high gradient-high intensity magnetic roll separators. The iron ore concentration process may further include a regrinding step for ores with fine liberation sizes. The process may also be a fully dry concentration process.

In another embodiment, the invention provides an iron ore concentration process with dry grinding circuit, dry desliming and mixed (dry and wet) concentration, wherein the process is adapted for concentration of iron ores with one stage of grinding, including for ores with a) coarse liberation sizes, and wherein the process comprises the steps of: a) crushing an ore; b) dry grinding of the ore crushed in step a); c) dry desliming of the ore grinded in step b); d) adding water to the ore deslimed in step c); e) floating or performing a wet high intensity magnetic separation, resulting in a reject that is separated; and f) filtering to obtain a concentrated product. Step b) may be performed by pneumatic classifiers with a cut between about 90%<37 μm and about 90%<5 μm. Step e) may further result in tailings, wherein the process further comprises: filtering the tailings and mixing the tailings with a dry sludge for dry stacking. Water from filtering step f) may be recirculated for use in step e) of the iron ore concentration process. The process may further comprise a wet high intensity magnetic separation.

In yet another embodiment, the invention provides an iron ore concentration process with dry grinding circuit, dry desliming and mixed (dry and wet) concentration, wherein the process is adapted for concentration of iron ores with two stages of grinding, including for ores with fine liberation sizes and wherein the process comprises the steps of: A) crushing an ore; B) dry grinding of the ore crushed in step a); C) dry desliming of the ore grinded in step b); D) adding water to the ore deslimed in step c); E) floating to generate a reject that is separated; F) regrinding the concentrate obtained in step e); and G) filtering to obtain a concentrated product.

### BRIEF DESCRIPTION OF THE DRAWINGS

FIG. 1 shows a flowchart for concentration of iron ores with one stage of grinding, usually used for ores with coarse liberation sizes known from the state of the art.

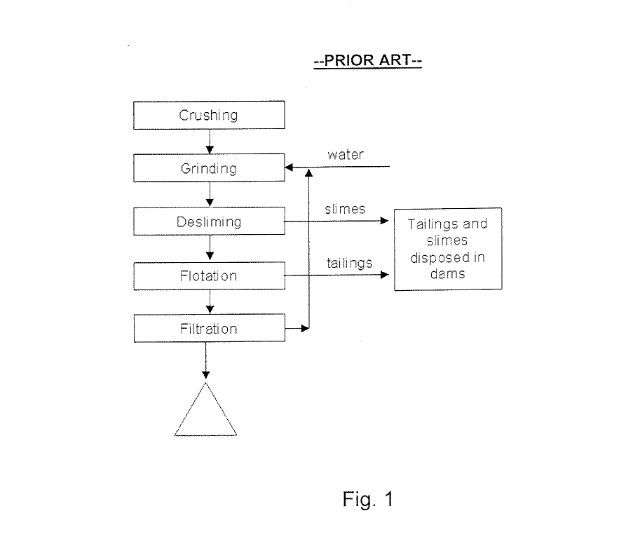

FIG. 2 shows a flowchart for concentration of ores with two stages of grinding, usually used for ores with fine liberation sizes known from the state of the art.

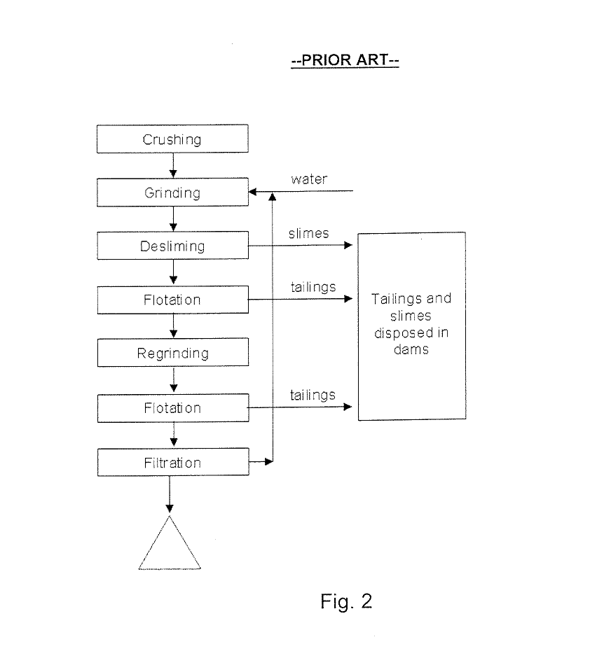

FIG. 3 shows a mixed flowchart (dry and wet) for concentration of ores with one stage of grinding, usually used for ores with coarse liberation sizes according to the present invention.

FIG. 4 shows a mixed flowchart (dry and wet) for concentration of iron ores with two stages of grinding, usually used for ores with fine liberation sizes according to the present invention.

FIG. 5 shows a flowchart for dry concentration of iron ores with one stage of grinding, usually used for ores with coarse liberation sizes according to the present invention.

FIG. 6 shows a flowchart for dry concentration of iron ores with two stages of grinding, usually used for ores with fine liberation sizes according to the present invention.

### DETAILED DESCRIPTION OF THE INVENTION

In light of the above described results observed, the present invention describes an advantageous and effective process for the concentration of iron ores, which can be fully dry or mixed, part of the process being dry, part wet, thereby enhancing the process efficiency as a whole by increasing recovery of concentrators and increasing the useful life of the mines.

The following detailed description does not intend to, in any way, limit the scope, applicability or configuration of the invention. More specifically, the following description provides the necessary understanding for implementing the exemplary embodiments. When using the teachings provided herein, those skilled in the art will recognize suitable alternatives that can be used, without extrapolating the scope of the present invention.

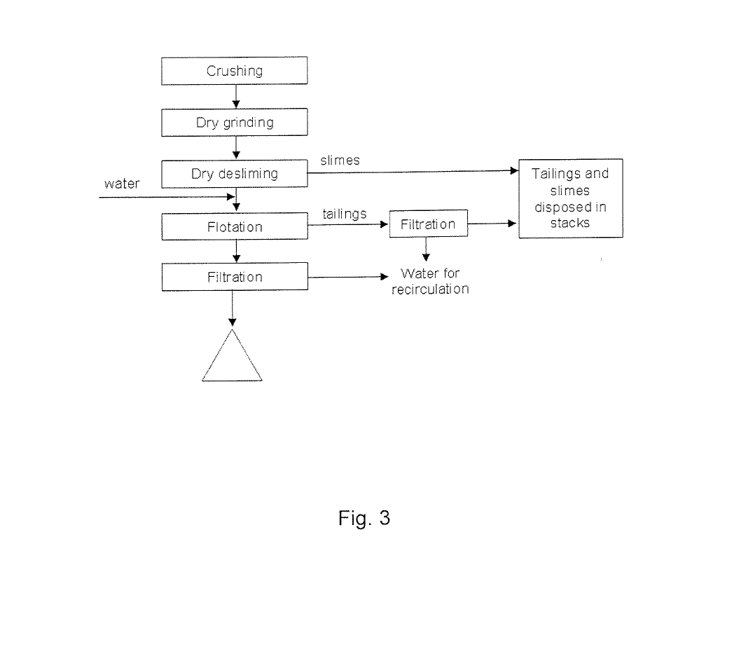

The present invention is directed to an ore concentration process, embodiments of which are shown in FIGS. 3 to 6.

The process of the present invention comprises the following steps:

| For a fully dry process | For a mixed (dry and wet) process |
|---|---|
| a) Crushing an ore; | a) Crushing an ore; |
| b) Dry grinding of the ore crushed | b) Dry grinding of the ore crushed in |
| in step a); | step a); |
| c) Dry desliming of the ore milled | c) Dry desliming of the ore milled in |
| in step b); | step b); |
| d) Magnetic separation of the ore | d) Adding water to the ore deslimed |
| deslimed in step c), resulting in a | in step c) |
| concentrate product and a reject | e) Flotation, resulting in a reject |
| that is separated | that is separated; |
| | f) Filtration, obtaining a |
| | concentrated product |

The terms grinding and milling may be used interchangeably. Grinding or milling is designed to break a solid material into smaller pieces.

According to preferred embodiments of the present invention, the slimes originating from desliming are dry produced by pneumatic classifiers, with a cut that may be between about 90%<37 μm and about 90% <5 μm. In the mixed process, tailings from flotation should be filtered and mixed to the dry sludge for placement into piles. The water from filtering the tailings is recirculated in the concentration.

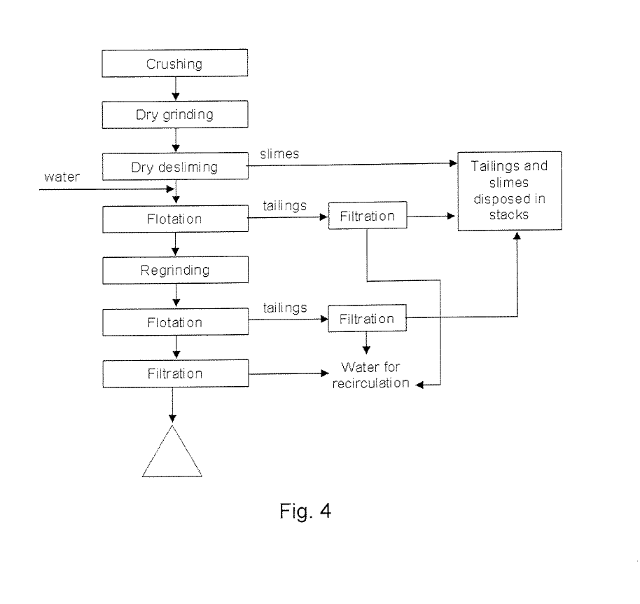

The first concentration stage shown in FIGS. 3 and 4 can be replaced by wet high intensity magnetic separation.

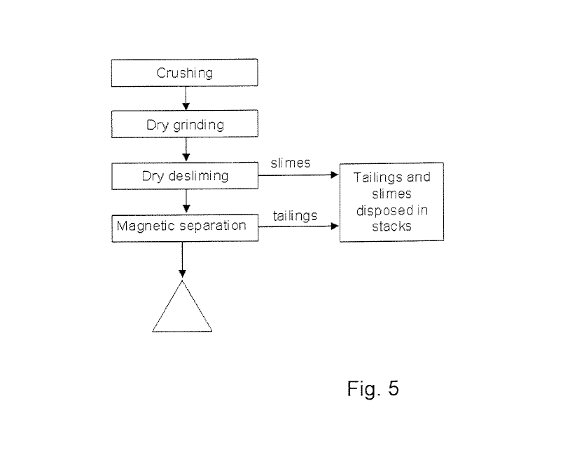

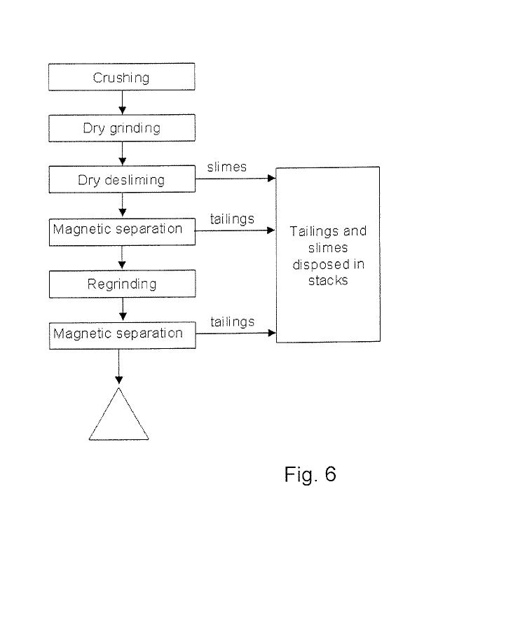

Alternatively to wet concentration, a fully dry concentration process is presented in FIGS. 5 and 6, in which concentration is performed firstly by magnetic drums using a combination of low and medium intensity magnetic field and afterwards by high gradient-high intensity magnetic roll separators.

The need for desliming in the process of concentration by flotation is well known. However, the ultrafines also adversely affect the dry magnetic concentration. As a result of the stage of dry desliming, the process according to the present invention has an advantage in relation to the conventional path of dry concentration, where there is no desliming. An example is shown in Tables 1 and 2 below.

TABLE 1
Results of magnetic concentration of deslimed sample.

| Stage | Flow | Mass (g) | Fe | SiO₂ |
|---|---|---|---|---|
| 1^{st} stage medium intensity | Feed | 7820.6 | 42.98 | 36.35 |
| magnetic drum | Concentrate 1 | 3164.3 | 67.49 | 2.78 |
| | Tail 1 | 4656.3 | 28.63 | 58.41 |
| 2^{nd} stage medium intensity | Concentrate 2 | 703.6 | 67.41 | 2.96 |
| magnetic drum | Tail 2 | 3952.7 | 20.44 | 69.43 |
| 3^{rd} stage high gradient high | Concentrate 3 | 2043.9 | 37.68 | 43.39 |
| intensity magnetic roll | Tail 3 | 1908.8 | 1.98 | 97.31 |
| 4^{th} stage high intensity roll | Concentrate 4 | 1054.4 | 64.14 | 6.80 |
| | Tail 4 | 989.5 | 10.63 | 81.34 |

| | | | |
|---|---|---|---|
| Final Concentrate | 4922.3 | 66.76 | 3.67 |
| Final Tail | 2898.3 | 4.93 | 91.86 |

| | |
|---|---|
| Mass yield (%) | 61.54 |
| Metallurgical recovery (%) | 95.59 |
| Gaudin's selectivity index | 18.41 |

TABLE 2
Results of magnetic concentration of non-deslimed sample.

| Stage | Flow | Mass (g) | Fe | SiO₂ |
|---|---|---|---|---|
| 1^{st} stage medium intensity | Feed | 8833.3 | 42.00 | 37.80 |
| magnetic drum | Concentrate 1 | 2372.2 | 59.28 | 12.72 |
| | Tail 1 | 6461.1 | 38.08 | 44.04 |
| 2^{nd} stage medium intensity | Concentrate 2 | 2031.8 | 60.87 | 10.66 |
| magnetic drum | Tail 2 | 340.4 | 52.89 | 22.77 |
| 3^{rd} stage high gradient high | Concentrate 3 | 62.3 | 60.97 | 10.83 |
| intensity magnetic roll | Tail 3 | 6398.8 | 35.47 | 47.45 |

| | | | |
|---|---|---|---|
| Final Concentrate | 2094.1 | 60.87 | 10.67 |
| Final Tailing | 6739.2 | 36.35 | 46.20 |

| | |
|---|---|
| Mass yield (%) | 23.04 |
| Metallurgical recovery (%) | 33.99 |
| Gaudin's selectivity index | 2.69 |

Table 1 shows that with the stage of desliming it was possible to obtain a concentrate with 66.76% Fe and tailings with just 4.93% Fe. However, the same sample that was not deslimed generated a concentrate with Fe content of 60.87%, which does not meet market specifications and tailings with 36.35% Fe, which causes a major loss of useful mineral.

The advantages obtained with the process of the present invention:
Disposal of coarse and ultrafine tails in stacks reducing the environmentally impacted areas in comparison with the large areas needed for the wet process inherent to the dam arrangement form.
Enhanced processing efficiency as a whole increasing recovery of concentrators and whereby increasing the useful life of the mines.
Enhanced quality of the generated concentrate, which has a higher Fe content and lower SiO₂ content compared to the conventional process.

1. An iron ore concentration process with grinding circuit, dry desliming and dry concentration, wherein the process comprises the steps of:
a) crushing an ore;
b) dry grinding of the ore crushed in step a);
c) dry desliming of the ore grinded in step b); and
d) magnetically separating the ore deslimed in step c), resulting in a concentrate product and a reject that is separated.

2. The iron ore concentration process according to claim 1, wherein step b) is performed by pneumatic classifiers, with a cut between about 90%<37 μm and about 90%<5 μm.

3. The iron ore concentration process according to claim 1, wherein step d) is performed by magnetic drums using a combination of low and medium intensity magnetic fields followed by high gradient-high intensity magnetic roll separators.

4. The iron ore concentration process according to claim 1, wherein the process is applied for concentration of iron ores with one stage of grinding, including ores with coarse liberation sizes.

5. The iron ore concentration process according to claim 1, wherein the process is applied for concentration of iron ores with two stages of grinding and regrinding, including for ores with fine liberation sizes.

6. The iron ore concentration process according to claim 1, wherein the process is a fully dry concentration process.

7. An iron ore concentration process with dry grinding circuit, dry desliming and mixed (dry and wet) concentration, wherein the process is applied for concentration of iron ores with one stage of grinding, with coarse liberation sizes, and wherein the process comprises the steps of:
a) crushing an ore;
b) dry grinding of the ore crushed in step a);
c) dry desliming of the ore grinded in step b);
d) adding water to the ore deslimed in step c)
e) floating or performing a wet high intensity magnetic separation, resulting in a reject that is separated; and
f) filtering to obtain a concentrated product.

8. The iron ore concentration process according to claim 7, wherein step b) is performed by pneumatic classifiers with a cut between about 90%<37 μm and about 90%<5 μm.

9. The iron ore concentration process according to claim 7, wherein step e) further results in tailings, the process further comprising: filtering the tailings and mixing the tailings with a dry sludge for dry stacking.

10. The iron ore concentration process according to claim 7, wherein water from the filtering step f) is recirculated for use in step e) of the iron ore concentration process.

11. An iron ore concentration process with dry grinding circuit, dry desliming and mixed (dry and wet) concentration, wherein the process is adapted for concentration of iron ores with two stages of grinding, including for ores with fine liberation sizes, wherein the process comprises the steps of:
A) crushing an ore;
B) dry grinding of the ore crushed in step a);
C) dry desliming of the ore grinded in step b);
D) adding water to the ore deslimed in step c);
E) floating to generate a reject that is separated;
F) regrinding the concentrate obtained in step e); and
G) filtering to obtain a concentrated product.

12. The iron ore concentration process according to claim 11, wherein step b) is performed by pneumatic classifiers with a cut between about 90%<37 μm and about 90%<5 μm.

13. The iron ore concentration process according to claim 11, wherein step e) further results in tailings, the process further comprising: filtering the tailings and mixing the tailings with a dry sludge for dry stacking.

14. The iron ore concentration process according to claim 11, wherein water from the filtering step g) is recirculated for use in step e).

15. The iron ore concentration process according to claim 11, wherein the floating or the performing of the wet high intensity magnetic separation comprises the performing of the wet high intensity magnetic separation.

16. The iron ore concentration process according to claim 11, wherein the floating or the performing of the wet high intensity magnetic separation comprises the floating.

17. The iron ore concentration process according to claim 9, wherein the water from filtering step f) is recirculated for use in step e).
